(19) United States
(12) Patent Application Publication
(10) Pub. No.: US 2025/0349130 A1
(43) Pub. Date: Nov. 13, 2025

(54) MAPPING FOR VEHICLE PARKING

(71) Applicant: GM GLOBAL TECHNOLOGY OPERATIONS LLC, Detroit, MI (US)

(72) Inventors: Jungwoog Sun, Incheon (KR); Hankyu Kim, Incheon (KR); Bongbum Back, Incheon (KR); Curtis L. Hay, Petoskey, MI (US); Gaurav Talwar, Novi, MI (US)

(73) Assignee: GM GLOBAL TECHNOLOGY OPERATIONS LLC, Detroit, MI (US)

(21) Appl. No.: 18/659,172

(22) Filed: May 9, 2024

(51) Int. Cl. G06V 20/58; G06T 7/579

(52) U.S. Cl. CPC G06V 20/586; G06T 7/579; G08G 1/143; G06T 2207/30264

(57) ABSTRACT

A system and method for mapping vehicle parking includes receiving, by a global navigation satellite system (GNSS) receiver, located within a vehicle, a GNSS signal, where based on the GNSS signal, a position of the vehicle is determined. One or more vehicle movement sensors are configured to track, upon entering into a parking structure with a subsequent loss of reception of the GNSS signal, a movement of the vehicle within the parking structure. An optical sensor, in the vehicle, identifies vehicle location information within the parking structure where one or more sensors within the vehicle map, based on the tracking and identifying, use simultaneous localization and mapping (SLAM), to generate parking space mapping data. Upon cessation of movement of the vehicle, a parking state of the vehicle is initiated where a determination is made of a parking space position of the parked vehicle within the parking structure.

### INTRODUCTION

Vehicles are a staple of everyday life. Special use cameras, microcontrollers, laser technologies, and sensors may be used in many different applications in a vehicle. Cameras, microcontrollers, and sensors may be utilized in enhancing automated structures that offer state-of-the-art experience and services to the customers, for example in tasks such as automated parking, parking assist, body control, camera vision, information display, security, autonomous controls, etc.

The parking of a vehicle may present a number of challenges, including finding a parking space and then remembering where the vehicle was parked. The use of traditional tools such as global positioning systems (GPS) to assist may also be ineffective in enclosed parking structures, such as an underground parking garage where GPS signals fail to penetrate. Accordingly, it is desirable to map a parking structure using a vehicle's sensors and to determine the final parking position of the vehicle without the use of a GPS or global navigation satellite systems (GNSS).

### SUMMARY

Disclosed herein are a system and methods for mapping vehicle parking based on vehicle sensor data. As disclosed herein, a method for mapping vehicle parking may include receiving, by a sensor in a vehicle, a global navigation satellite system (GNSS) signal and then determining, based on the GNSS signal, a position of the vehicle. The method may also include entering, by the vehicle, into a parking structure, wherein, based on a location of the vehicle in the parking structure, a loss of reception of the GNSS signal. The method may continue with tracking, based on one or more vehicle movement sensors, a movement of the vehicle within the parking structure after the loss of reception of the GNSS signal and then identifying, using an optical sensor in the vehicle, vehicle location information within the parking structure. The method may continue with mapping, using one or more sensors within the vehicle and based on the tracking and identifying, based on simultaneous localization and mapping (SLAM), parking space mapping data. The method may continue by recognizing, upon cessation of movement of the vehicle, using one or more sensors within the vehicle, a parking of the vehicle and then determining a parking space position of the parked vehicle within the parking structure.

Another aspect of the method may include where recognizing the parking of the vehicle further comprises determining that a transmission of the vehicle has been placed into a parking state and that an engine of the vehicle has been turned off.

Another aspect of the method may include transmitting the parking space mapping data to a mobile communication device.

Another aspect of the method may include transmitting the parking space mapping data from the mobile communication device to a server.

Another aspect of the method may include transmitting the parking space position of the parked vehicle to a mobile communication device.

Another aspect of the method may include augmenting, by a-priori parking space mapping information, the parking space mapping data.

Another aspect of the method may include determining, using dynamic programming, an optimized path to an open parking space within the parking structure.

Another aspect of the method may include where the determining of the optimized path is based on a location coordinate of a parking lot entrance, a speed of the vehicle, an elapsed time of travel of the vehicle, a direction of the vehicle, and a-priori parking space mapping information.

Another aspect of the method may include sharing the parking space mapping data with a third-party parking software application.

Another aspect of the method may include receiving from a server, parking space mapping data.

As disclosed herein, a system for mapping vehicle parking may include a global navigation satellite system (GNSS) receiver, located within a vehicle, configured to receive a GNSS signal, wherein, based on the GNSS signal, a position of the vehicle may be determined. The system may also include one or more vehicle movement sensors configured to track, upon entering into a parking structure and a subsequent loss of reception of the GNSS signal, a movement of the vehicle within the parking structure. The system may also include an optical sensor, in the vehicle, configured to identify vehicle location information within the parking structure and also one or more sensors, within the vehicle, configured to map, based on the tracking and identifying, using simultaneous localization and mapping (SLAM), parking space mapping data. The system may also include where the one or more sensors, within the vehicle, are further configured to recognize, upon cessation of movement of the vehicle, a parking of the vehicle, where a determination may be made of a parking space position of the parked vehicle within the parking structure.

Another aspect of the disclosure may be a system that includes a transmitter, within the vehicle, to transmit the parking space mapping data to a mobile communication device.

Another aspect of the disclosure may be a system where the mobile communication device is further configured to transmit the parking space mapping data to a server.

Another aspect of the disclosure may be a system where a transmitter, within the vehicle, to transmit the parking space mapping data to a server.

Another aspect of the disclosure may be a system that includes a transmitter to transmit the parking space position of the parked vehicle to a mobile communication device.

Another aspect of the disclosure may be a system that includes a receiver, located in the vehicle, to receive, an optimized path to an open parking space within the parking structure determined by dynamic programming.

Another aspect of the disclosure may be a system where the determining of the optimized path is based on a location coordinate of a parking lot entrance, a speed of the vehicle, an elapsed time of travel of the vehicle, a direction of the vehicle, and a-priori parking space mapping information.

Another aspect of the disclosure may be a system that includes a receiver, located within the vehicle, to receive from a server, parking space mapping data.

Another aspect of the disclosure may be a system that includes a receiver, located within the vehicle, to receive, a-priori parking space mapping information.

Another aspect of the disclosure may include a method for mapping vehicle parking that includes receiving, by a sensor in a vehicle, a global navigation satellite system (GNSS) signal and determining, based on the GNSS signal, the position of the vehicle. The method may include entering, by the vehicle, into a parking structure, where, based on the location of the vehicle in the parking structure, a loss of reception of the GNSS signal. The method may continue by tracking, based on one or more vehicle movement sensors, a movement of the vehicle within the parking structure after the loss of reception of the GNSS signal and then identifying, using an optical sensor in the vehicle, vehicle location information within the parking structure. The method may include mapping, using one or more sensors within the vehicle and based on the tracking and identifying and on simultaneous localization and mapping (SLAM), parking space mapping data. The method may then include recognizing, upon cessation of movement of the vehicle, using one or more sensors within the vehicle, a parking of the vehicle, wherein the recognizing the parking of the vehicle further includes determining that a transmission of the vehicle has been placed into a parking state and that an engine of the vehicle has been turned off. The method may also include determining a parking space position of the parked vehicle within the parking structure and transmitting the parking space mapping data and the parking space position of the parked vehicle to a mobile communication device. The method may also include transmitting the parking space mapping data from the mobile communication device to a server and determining, using dynamic programming, an optimized path to an open parking space within the parking structure.

The above features and advantages, and other features and attendant advantages of this disclosure, will be readily apparent from the following detailed description of illustrative examples and modes for carrying out the present disclosure when taken in connection with the accompanying drawings and the appended claims. Moreover, this disclosure expressly includes combinations and sub-combinations of the elements and features presented above and below.

### BRIEF DESCRIPTION OF THE DRAWINGS

The accompanying drawings, which are incorporated into and constitute a part of this specification, illustrate implementations of the disclosure and together with the description, serve to explain the principles of the disclosure.

FIG. 1 is an illustration of a variety of possible vehicle sensors, in accordance with the disclosure.

FIG. 2 is an illustration of vehicle trace coordination data from multiple vehicle sensors, in accordance with the disclosure.

FIG. 3 depicts visual location indicators within a parking structure, in accordance with the disclosure.

FIG. 4 is an illustration of a parking lot mapping process, in accordance with the disclosure.

FIG. 5 depicts possible trace data as part of the parking lot mapping process, in accordance with the disclosure.

FIG. 6 is an illustration of a parking lot mapping process over time, in accordance with the disclosure.

FIG. 7 depicts possible trace data as part of a multiple pass parking lot mapping process, in accordance with the disclosure.

FIG. 8 depicts further refined possible trace data as part of a multiple pass parking lot mapping process, in accordance with the disclosure.

FIG. 9 depicts a vehicle mapping process over multiple floors withing a parking structure, in accordance with the disclosure.

FIG. 10 depicts the use of dynamic programing to determine the optimal available parking spaces within the parking structure, in accordance with the disclosure.

FIG. 11 is a flowchart of a method for generating a smart parking mapping system, in accordance with the disclosure.

The appended drawings are not necessarily to scale and may present a somewhat simplified representation of various preferred features of the present disclosure as disclosed herein, including, for example, specific dimensions, orientations, locations, and shapes. Details associated with such features will be determined in part by the particular intended application and use environment.

### DETAILED DESCRIPTION

The present disclosure is susceptible of embodiments in many different forms. Representative examples of the disclosure are shown in the drawings and described herein in detail as non-limiting examples of the disclosed principles. To that end, elements and limitations described in the Abstract, Introduction, Summary, and Detailed Description sections, but not explicitly set forth in the claims, should not be incorporated into the claims, singly or collectively, by implication, inference, or otherwise.

For purposes of the present description, unless specifically disclaimed, use of the singular includes the plural and vice versa, the terms “and” and “or” shall be both conjunctive and disjunctive, and the words “including”, “containing”, “comprising”, “having”, and the like shall mean “including without limitation”. Moreover, words of approximation such as “about”, “almost”, “substantially”, “generally”, “approximately”, etc., may be used herein in the sense of “at, near, or nearly at”, or “within 0-5% of”, or “within acceptable manufacturing tolerances”, or logical combinations thereof. As used herein, a component that is “configured to” perform a specified function is capable of performing the specified function without alteration, rather than merely having potential to perform the specified function after further modification. In other words, the described hardware, when expressly configured to perform the specified function, is specifically selected, created, implemented, utilized, programmed, and/or designed for the purpose of performing the specified function.

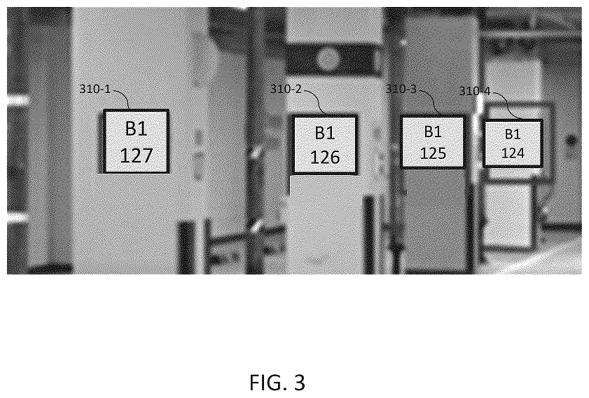

Referring to the drawings, the left most digit of a reference number identifies the drawing in which the reference number first appears (e.g., a reference number ‘310’ indicates that the element so numbered is first labeled or first appears in FIG. 3). Additionally, elements which have the same reference number, followed by a different letter of the alphabet or other distinctive marking (e.g., an apostrophe), indicate elements which may be the same in structure, operation, or form but may be identified as being in different locations in space or recurring at different points in time (e.g., reference numbers “110a” and “110b” may indicate two different input devices which may be functionally the same, but may be located at different points in a simulation arena).

Vehicles have become computationally advanced and equipped with multiple microcontrollers, sensors, processors, and control systems, including for example, autonomous vehicle and advanced driver assistance systems (AV/ADAS) such as adaptive cruise control, automated parking, automatic brake hold, automatic braking, evasive steering assist, lane keeping assist, adaptive headlights, backup assist, blind spot detection, cross traffic alert, local hazard alert, and rear automatic braking may depend on information obtained from cameras and sensors on a vehicle. Such systems may also provide a wealth of information about the vehicle, including, for example, location, automatic assistance sensors, occupancy data, motion sensors, and last mile dead reckoning to name a few. These systems may also provide detailed data as to the operation and location of a vehicle. Such information may be combined with remote databases, for example a cloud-based operation, to share data with other vehicles to augment parking data and/or provide access from third party providers.

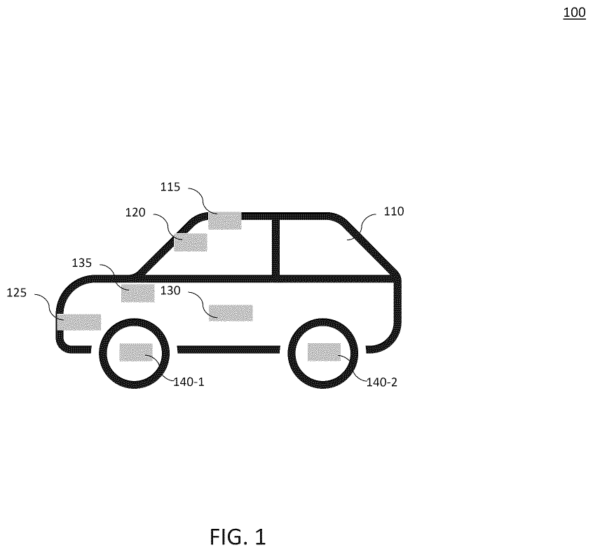

FIG. 1 is an illustration of a vehicle with integrated sensors 100, according to an embodiment of the present disclosure. Such sensors may assist in determining information about the location of the vehicle, its surroundings, and operational characteristics such as speed, direction, steering angle, etc. For example, vehicle 110 may include a Light Detection And Ranging (Lidar) sensor 115, a camera sensor 120, an ultrasonic sensor 125, an inertial measurement unit (IMU) sensor 130, a steering angle sensor 135, and wheel speed sensors 140-1 and 140-2.

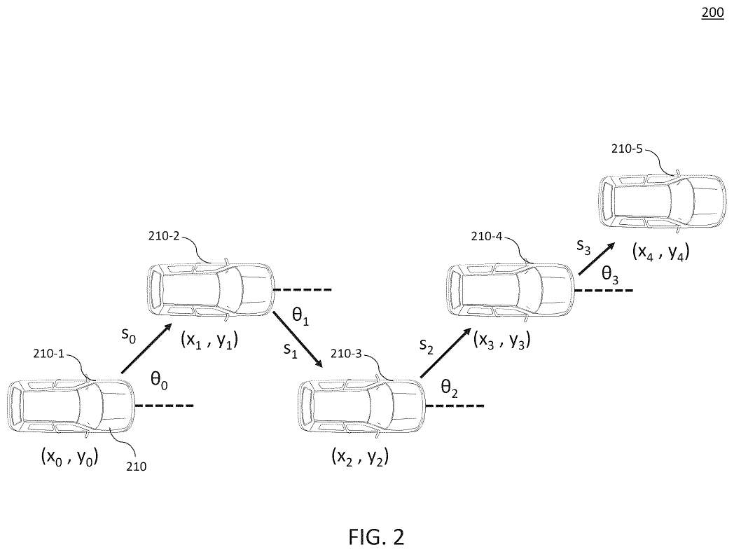

FIG. 2 is an illustration of vehicle trace coordination data 200 from multiple vehicle sensors, according to an embodiment of the present disclosure. Vehicle sensors as shown in FIG. 1, for example steering angle sensor 135, wheel speed sensors 140-1 and 140-2, and IMU sensor 130 may be used to track the position of vehicle 110 over time without the use of a satellite navigation system. As shown in FIG. 2, vehicle 210, shown at an initial position and labeled 210-1 starts at a position of (x₀, y₀). After a first time period the vehicle, shown as 210-2, has detected at steering position of so at an angle of θ₀, and given the elapsed time and input from the wheel speed sensors, the vehicle is calculated to be at position (x₁, y₁). After a second time period the vehicle, shown as 210-3, has detected at steering position of s₁ at an angle of θ₁, and given the elapsed time and input from the wheel speed sensors, the vehicle is calculated to be at position (x₂, y₂). After a third time period the vehicle, shown as 210-4, has detected at steering position of s₂ at an angle of θ₂, and given the elapsed time and input from the wheel speed sensors, the vehicle is calculated to be at position (x₃, y₃). After a fourth time period the vehicle, shown as 210-5, has detected at steering position of s₃ at an angle of θ₃, and given the elapsed time and input from the wheel speed sensors, the vehicle is calculated to be at position (x₄, y₄). Thus, FIG. 2 illustrates the use of vehicle sensors, without satellite signals, to detect the location of the vehicle over time, which may also be referred to as the “last mile” or “dead reckoning” positioning.

FIG. 3 is an illustration of visual location indicators within a parking structure, according to an embodiment of the present disclosure. Sensors with vehicle 110 or vehicle 210 may utilize its camera sensor 120 to perform an optical character recognition of pillar numbers or other location signage or markings to further indicate the vehicle's position as well as to include within the parking space mapping process. For example, FIG. 3 is an example shows four columns with signage 310-1, 310-2, 310-3, and 310-4. In this example, the signage illustrates a level, e.g., “B1” and a column location, e.g., 124, 125, 126, and 127.

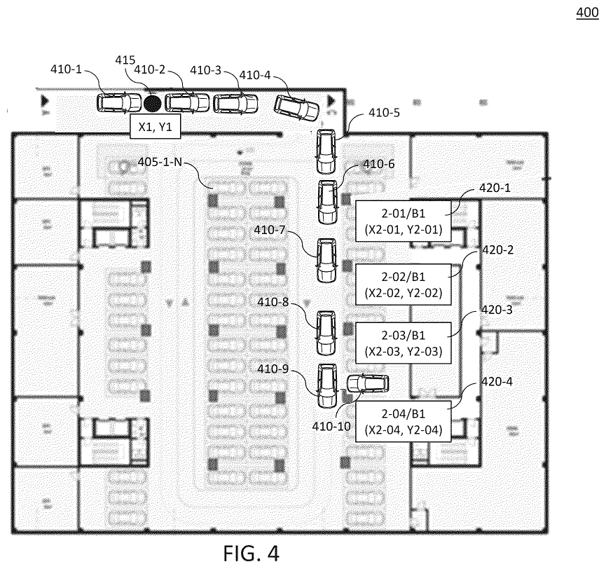

FIG. 4 is an illustration of a parking lot mapping process 400, according to an embodiment of the present disclosure. The parking lot mapping process 400 may begin with a vehicle, for example, vehicle 410, shown in multiple positions over time, starting with entering a parking structure at 410-1. However, at position 415, marked as (X1, Y1), satellite reception by vehicle 410 may be lost. Thus, as described in FIG. 2, vehicle 410 may enter into the parking structure and start the mapping process but may utilize its own internal sensors for tracking. The vehicle's internal sensors may track the vehicle through positions 410-2, 410-3, 410-4 where a steering angle sensor and wheel speed sensors may indicate the start of a turn, through to positions 410-5, 410-6. 410-7, 410-8, 410-9, and finally into a parking spot at 410-10. In addition, during the travel of vehicle 410, especially from positions 410-6 through 410-9, the vehicle camera sensors may also obtain position information from pillar numbers within the structure shown as pillar information 420-1, 420-2, 420-3, and 420-4 through the use of optical character recognition. For example, the pillar may include information such as a section or level number, for example, in these showing sections 2-01, 2-02, 2-02, 2-03, and 2-04, which are located on level “B1.” The location of the pillars may also be associated with the dead reckoning position of the vehicle through its internal sensors, for example, positions as shown in a two dimensional grid orientation, (X2-01, Y2-01), (X2-02, Y2-02), (X2-03, Y2-03), (X2-04, Y2-04). In this example, x₂ illustrates a column position in the X axis with the 2 indicating a column number and similarly Y2 illustrates a column position in the Y axis with the 2 indicating a column number. Also shown in FIG. 4 are possible parking spaces 405-1 through to 405-N. Further, the numbering scheme shown here is purely exemplary and may take any form or logic without deviating from the intention of the disclosure.

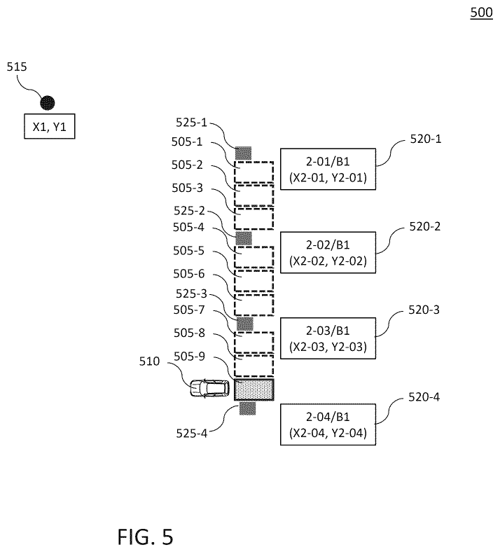

FIG. 5 depicts possible trace data as part of a parking lot mapping process 500, according to an embodiment of the present disclosure. As a result of the mapping process illustrated in FIG. 4, FIG. 5 may illustrate the results of an initial parking structure mapping process. Those results may also be considered the start of an artificial intelligence or machine learning process for the mapping of a particular parking structure. For example, FIG. 5 may illustrate the loss of a navigation satellite signal starting at position 515, marked as (X1, Y1) and as the vehicle 410 in FIG. 4 proceeded through positions 410-6 to 410-10, its sensors may be able to identify pillars, e.g., pillars 525-1, 525-2, 525-3, and 525-4 with posted positional information, e.g., 520-1, 520-2, 520-3, 520-4. Further the vehicle may be able to discern and calculate possible parking spaces, illustrated as parking spaces 505-1, 505-2, 505-3, 505-4, 505-5, 505-6, 505-7, 505-8, and 505-9. Also, with the knowledge of where vehicle 510 finally parked, parking space 505-9 may also be identified.

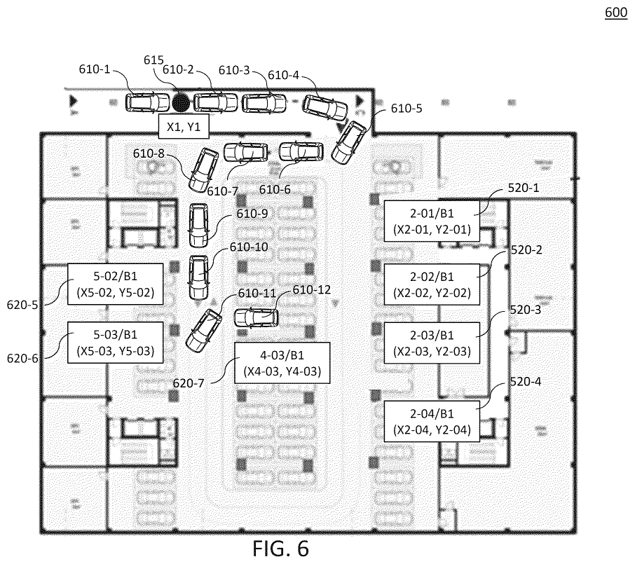

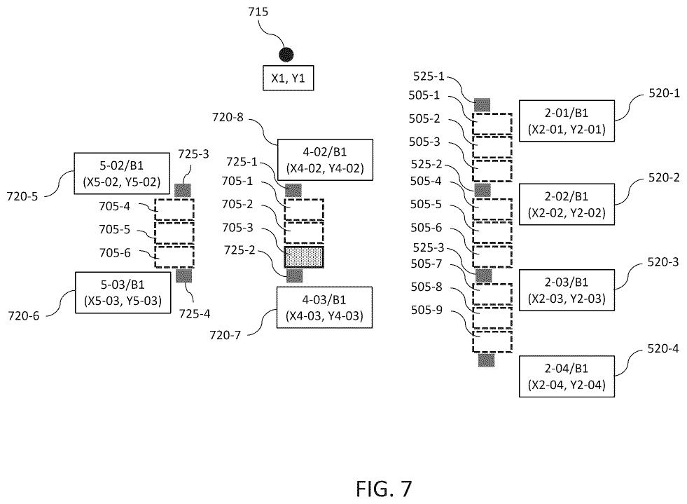

FIG. 6 is an illustration of the parking lot mapping process 600 reiterated over time, according to an embodiment of the present disclosure. Building upon the information gathered in FIG. 5, FIG. 6 continues to add additional detail. For example, vehicle 610 at position 610-1 is in consistent or regular GNSS or GPS signal reception and thus able to determine its position. However, after crossing point 615 the GNSS or GPS signal may be lost which in turn is recognized as the starting point of the parking structure mapping and recognition process. As discussed, once the vehicle loses satellite reception it is operating in a dead reckoning only mode, relying on its internal sensors to track steering angles, wheel speed, and inertial management unit to calculate its position. Vehicle 610 proceeds along positions 610-2, 610-3, and 610-4 as was also done in FIG. 4. However, at position 610-5 the vehicle deviates to a new path and continues down a different aisle, gathering mapping and sensing position information from pillar numbers within the structure shown as pillar information 620-5, 620-6, and 620-7 as the vehicle continues through positions 610-6, 610-7, 610-8, 610-9, 610-11, and finally parking in position 610-12. Pillar information 620-5, 620-6, and 620-7, for example, showing the level and column locations as well as the (X, Y) coordinates of (X4-03, Y4-03), (X5-02, Y5-02), and (X5-03, Y5-03). The information gathered in FIG. 6 may then be added to the previously collected information to generate the trace data of FIG. 7, depicting a more comprehensive overview of the parking structure.

FIG. 7 illustrates the data gathered in FIGS. 4 and 5, shown as parking spaces 505-1 through 505-9 and with position information from pillar numbers shown as 520-1-520-4, according to an embodiment of the present disclosure. In addition, new parking space information has been added, gathered after passing the loss of navigation satellite signal position 715, marked as (X1, Y1) that may include parking spaces 705-1, 705-2, 705-3, 705-4, 705-5, and 706-6. New position information from pillar numbers 725-1, 725-2, 725-3, and 725-4 shown as posted positional information 720-5, 720-6, 720-7, and 720-8, (also showing the level and column locations as well as the X, Y coordinates), may also be captured.

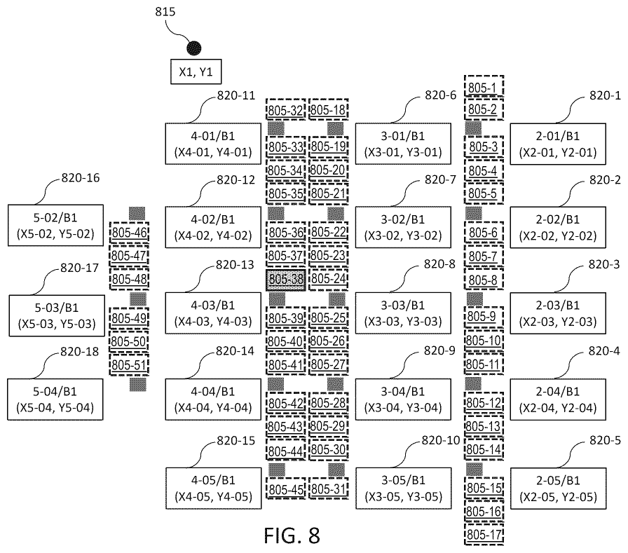

FIG. 8 represents the culmination of parking lot mapping data gathering, according to an embodiment of the present disclosure. FIG. 8 shows the capture and recognition of pillar information for the entire floor of the parking structure, including pillar information 820-1 through 820-18. In this example the pillar information includes the parking level, e.g., B1, the aisle and column location, e.g., 2-01-2-05, 3-01-3-05, 4-01-4-05, and 5-02-5-04, and the calculated parking lot spaces labeled 805, from 805-1 through to 805-51. As previously discussed, this data is a compilation of dead reckoning positioning data due to the loss of satellite navigation signals at point 815, marked as location (X1, Y1). The data may also include an actual location of a specific parked vehicle, for example as shown by shaded parking spot location 805-38. For completeness, all of the column and level information, including the associated (X, Y) coordinates is shown.

The method and processes of mapping described thus far may also be referred to as Simultaneous Localization and Mapping (SLAM), where by using a vehicle's internal sensors, e.g., camera, optical recognition, ultrasonic, wheel speed, IMU, LIDAR, a map may be constructed and drawn using SLAM technology from the time the vehicle enters the parking structure and may display the parking location information to the driver in addition to forwarding such information back to a central server as will be discussed.

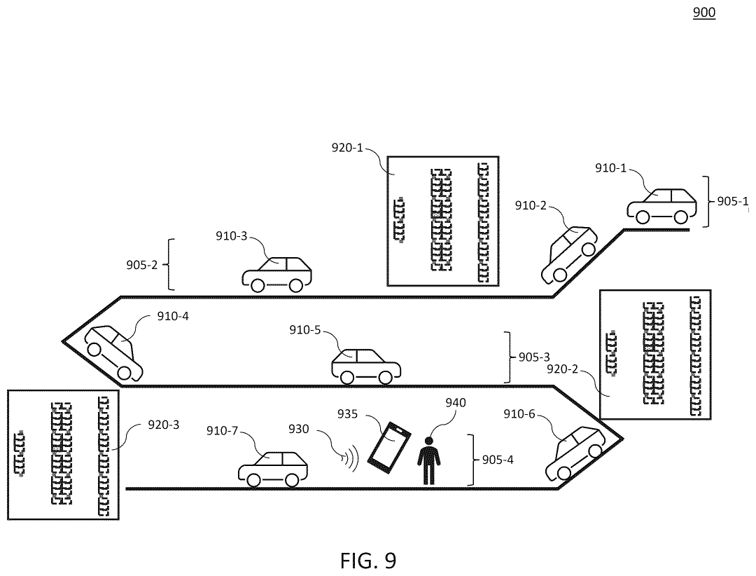

FIG. 9 is an illustration of a mapping process 900 over multiple floor levels within a parking structure, according to an embodiment of the present disclosure. The process discussed in FIG. 8 may further be extended to pertain to multiple parking levels using a vehicle's internal sensors, e.g., IMU, camera, LIDAR, ultrasonic sensor, wheel speed sensors, and steering angle sensors to detect changes in elevation and movement to a different level. For example, vehicle 910, at position 910-1 may be represented at level 905-1 as the entrance to an underground parking structure. The location and level may be determined by satellite navigation reception in addition to possible image recognition by the vehicle's cameras.

At position 910-2 the vehicle is shown entering a down ramp into a parking structure as would be sensed by the vehicle's IMU sensor and possibly assisted with wheel speed data sensor information, steering angle sensor information, and camera and/or LIDAR image data. Such data may produce a trigger point in which the IMU sensor classifies the parking level to initiate the creation of a map. In an embodiment, the vehicle's camera may detect some image recognition as to the presence of the parking structure, for example, recognizing the letter “P” at the entrance (not shown) using satellite navigation and camera sensors.

In an embodiment, the vehicle may obtain any available parking structure mapping data from a server prior to entering the parking structure. In another embodiment, as will be further discussed, the vehicle may also update, based on its mapping, the parking structure mapping data upon leaving the parking structure when satellite communication may be restored. Such updated parking information may then be used and/or disseminated as appropriate in real-time or in an as needed manner to other family members, community members, or third parties as appropriate.

Such data may then place the vehicle, in this example, at a first underground level, e.g., level 905-2. As discussed in FIG. 8, vehicle 910, shown at position 910-3 may map parking spot data, or possibly prior to entering the underground parking structure, retrieve a mapping of the parking structure from a server, shown as level 905-2 map 920-1. Such previously created map information, based upon the current location information, may therefore be used to supplement any parking data gathered by the vehicle. In an embodiment, vehicle 910, at position 910-3 may also update information associated with map 920-1. As discussed with FIGS. 4-8, the vehicle's wheel speed sensor may calculate the distance traveled with its camera recording character information on the pillar as the vehicle moves and store it in the mapping map. The vehicle may also use its other sensors, e.g., cameras, lidar, ultrasonic, etc., to initiate the mapping process previously described.

The vehicle may again, at position 910-4 transition to another level, the transition being detected and recorded by sensors, for example, wheel speed sensors and an IMU sensor. At level 905-3 vehicle 910, at position 910-5 may also continue to gather and update information associated with map 920-2, which is the map associated with level 905-3. This process may continue for any number of parking levels, where such a number of levels shown is merely an example and not meant to be limiting. Vehicle 910, at position 910-6 is shown to descend to yet another level, level 905-4. As before, the transition from one level to another may be detected and recorded by sensors, for example, wheel speed sensors and an IMU sensor. At level 905-4 vehicle 910, at position 910-7 may also continue to gather and update information associated with map 920-3, the map associated with level 905-4.

FIG. 9 further describes where, in an embodiment, vehicle 910 finds an acceptable parking space. At that point, for example, at position 910-7, vehicle 910 is parked in a particular identified parking space, at which point vehicle 910 has stopped, and the driver 940 puts the transmission into a “parked” state and turns off the engine. At this point, vehicle 910 may be recognized as parked at which point the mapping process may cease.

In an embodiment, once vehicle 910 has been parked and turned off, the vehicle, may attempt to contact a server and send its acquired mapping data, but given that satellite communication may not be available, the vehicle may initiate communication with a user's communication device, for example smartphone 935 of driver 940, via a type of short-range connection 930, e.g., Bluetooth, ultra-wideband, etc., and communicate the acquired mapping data, possibly including the position of the parked vehicle. In such a situation, if the user regains satellite communication capabilities, e.g., when leaving the parking structure, the data may be uploaded to a server. The information may also convey the location and status of the vehicle to the user. In another embodiment, once the user returns to the parking structure, an application on the user's device may alert the user about the location, either by text, voice, or other method, of the vehicle. The application may also allow for the user to inquire as to the location of the vehicle that may include a verbal, text, or mapping or route feature as to finding the vehicle. Further, once the user is within a certain distance of the vehicle, a vehicle sensor may detect the presence of the user or sense the presence of a key-fob or other user device, e.g., a smartphone, and emit a visual or auditory signal to draw the user's attention. Further, as previously mentioned, once the driver returns to vehicle and exits the parking structure, upon obtaining a satellite communication connection, the vehicle may update its parking structure data to a server. Such updated parking information may include as previously described, the layout and mapping of the various parking levels, but it may also include enhanced mapping features such as the precise location of parked vehicles, the location of slanted ramps, flat levels, whether the ramps are for ascending or descending traffic, etc.

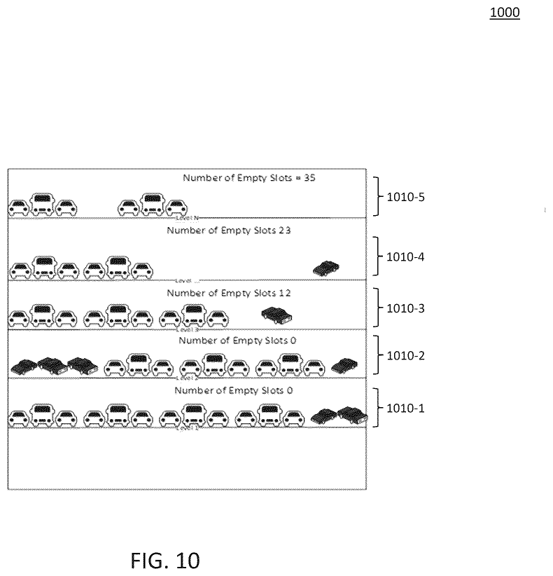

FIG. 10 depicts the use of dynamic programming 1000 to determine optimal available parking spaces within a parking structure, according to an embodiment of the present disclosure. Dynamic programming may be used to optimize the path to finding open parking spaces by using a-priori parking information. The closest physical parking spot may not be the fastest or easiest spot to access. For example, based upon which entrance in a parking structure the vehicle enters, the speed of the vehicle, the time elapsed before coming to a halt, the images captured by a vehicle camera, a-priori parking lot information such as the number of parking levels, the number of empty spots, and the direction of the vehicle, all of which data may be used to dynamically determine an optimal set of parking spots.

FIG. 10, as an example, shows a possible scenario of a five-level parking structure starting at the first level, level 1010-1, which indicates there are zero empty parking spaces. Further, the second level, level 1010-2, may also indicate zero empty parking spaces. The third level, level 1010-3, indicates twelve empty spaces while the fourth level, level 1010-4 indicates twenty-three empty spaces and the fifth level, level 1010-5 indicates thirty-five open spaces. Depending on at least the above referenced dynamic programing factors, e.g., the entrance in a parking structure in which the vehicle enters, the speed of the vehicle, the time elapsed before coming to a halt, the images captured by a vehicle camera, a-priori parking lot information such as the number of parking levels, the number of empty spots, and the direction of the vehicle, the most optimal parking space may not be the first, e.g., one of the twelve slots on parking level 1010-3.

For example, if the vehicle was located on level 1010-3 where there are twelve empty spaces, but the vehicle may be close to an up-ramp, the spaces on 1010-4 or 1010-5 may actually be faster to reach than those on level 1010-3. Thus, if dynamic programing knows that in past situations, a-priori information, showed that such spaces on the upper levels were reached quicker, then the system may indeed direct the vehicle to such an alternate space.

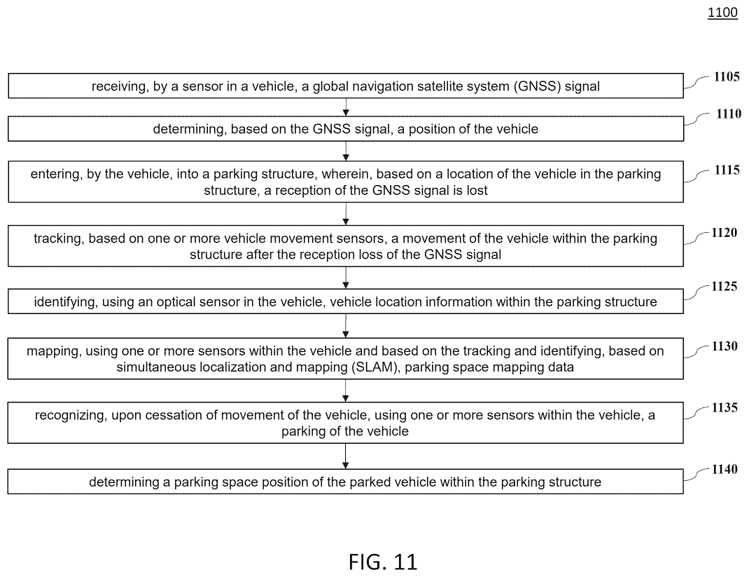

FIG. 11 shows an exemplary embodiment of method 1100 for mapping vehicle parking, according to an embodiment of the present disclosure. Method 1100 begins at step 1105 by receiving, by a sensor in a vehicle, a global navigation satellite system (GNSS) signal, or global positioning system (GPS) signal. At step 1110, the signal may be used by the vehicle to determine its position, in an embodiment, as the vehicle is about to enter a parking structure, such as described in FIG. 4, where vehicle 410 at position 410-1, is about to enter a parking structure and lose connectivity with any satellite communications. In an embodiment, the parking structure may be an underground parking structure. However, in other embodiments, the parking structure may be a multi-level above ground structure. Such an above ground structures may also experience a loss of satellite communications. In another embodiment, the parking structure may be that of a shopping mall, stadium, museum, etc.

At step 1115, the vehicle may enter into the parking structure, wherein based on the location of the vehicle in the parking structure, the reception of the GNSS or GPS signal is lost. Parking structures, whether above ground or below ground, may be constructed of materials that are not conducive to passing radio-based signals and thus at some point within the structure the signal will be lost. Such demarcations are illustrated in FIGS. 4-8 as coordinates X1, Y1, at which point location assistance by GNSS or GPS is no longer viable.

At step 1120, the vehicle, based on one or more of its vehicle movement sensors tracks the movement of the vehicle within the parking structure after the loss of reception of the GNSS or GPS signal. As discussed, once the vehicle loses connectivity with a satellite signal its location must be determined by other means. The vehicle may be equipped, as shown in FIG. 1, with a variety of sensors, for example Light Detection And Ranging (Lidar) sensor 115, a camera sensor 120, an ultrasonic sensor 125, an inertial measurement unit (IMU) sensor 130, a steering angle sensor 135, and wheel speed sensors 140-1 and 140-2. As described in FIG. 2, a vehicle's location may be determined using the vehicle sensors. For example, vehicle 210, shown at an initial position and labeled 210-1 starts at a position of (x₀, y₀). After a first time period the vehicle, shown as 210-2, has detected at steering position of so at an angle of θ₀, and given the elapsed time and input from the wheel speed sensors, the vehicle is calculated to be at position (x₁, y₁). After a second time period the vehicle, shown as 210-3, has detected at steering position of s₁ at an angle of θ₁, and given the elapsed time and input from the wheel speed sensors, the vehicle is calculated to be at position (x₂, y₂). After a third time period the vehicle, shown as 210-4, has detected at steering position of s₂ at an angle of θ₂, and given the elapsed time and input from the wheel speed sensors, the vehicle is calculated to be at position (x₃, y₃). After a fourth time period the vehicle, shown as 210-5, has detected at steering position of s₃ at an angle of θ₃, and given the elapsed time and input from the wheel speed sensors, the vehicle is calculated to be at position (x₄, y₄). Thus, FIG. 2 illustrates the use of vehicle sensors, without satellite signals, to detect the location of the vehicle over time, which may also be referred to as the “last mile” or “dead reckoning.”

At step 1125, the vehicle, using at least one optical sensor may identify vehicle location information within the parking structure. As discussed, first in FIG. 3, parking structures may post or paint visual location indicators on various pillars or walls within the structure to convey location information such as the parking level, section, and row information, sometimes also color-coding various sections. This information may assist the driver in locating where they have parked their car or assist in guiding the driver to a desired area of the parking structure. This is further shown in FIGS. 4-8 where the images are captured by the vehicle camera, and using optical character recognition, may store such information, for example in FIG. 8, pillar information 820-1 through 820-18.

At step 1130, using one or more sensors within the vehicle, based on the tracking, and identifying, based on simultaneous localization and mapping (SLAM), generate parking space mapping data. As previously discussed, the method and processes of mapping described a parking structure may also be referred to as Simultaneous Localization and Mapping (SLAM), that by using a vehicle's internal sensors, e.g., camera, optical recognition, ultrasonic, wheel speed, IMU, LIDAR, a map may be constructed and drawn of the parking structure using SLAM technology from the time the vehicle enters the parking structure. Such mapping may display the parking location information to the driver as well as transmitting such information to external servers. FIG. 8 described the detailed results of such SLAM mapping on a single parking level that may be extended to multiple levels as described in FIG. 9. In addition, to mapping the calculated parking spaces as shown in FIG. 8, the process may also include capturing occupied parking spaces and therefore the mapping data may convey the capacity and availability of parking spots in the parking structure to an outside source. In one embodiment, such availability may be shared, or sold, to third parties, for example, third party parking applications that provide real time parking availability.

At step 1135, upon cessation of movement of the vehicle, using one or more sensors within the vehicle, recognizing the parking state of the vehicle. As discussed, the method may include the recognizing, upon cessation of movement of the vehicle, using one or more sensors within the vehicle, a parking of the vehicle, wherein recognizing the parking of the vehicle further includes determining that a transmission of the vehicle has been placed into a parking state and that an engine of the vehicle has been turned off. As discussed in FIG. 9, vehicle 910 may find an acceptable parking space, in which, at that point, for example, at position 910-7, vehicle 910 is parked in a particular identified parking space, at which point vehicle 910 has stopped, and the driver puts the transmission into a “parked” state and turns off the engine. At this point, vehicle 910 may be recognized as parked at which point the mapping process may cease.

At step 1140 the method may continue by determining a parking space position of the parked vehicle within the parking structure. As discussed in FIG. 9, once vehicle 910 has been parked and turned off, the vehicle, may attempt to contact a server and send its acquired mapping data, but given that satellite communication may not be available, the vehicle may initiate communication with a user's communication device, for example smartphone 935 via a type of short-range connection 930, e.g., Bluetooth, ultra-wideband, etc., and communicate the acquired mapping data, possibly including the position of the parked vehicle. In such a situation, if the user regains satellite communication capabilities, e.g., when leaving the parking structure, the data may be uploaded to a server. The information may also convey the location and status of the vehicle to the user. In another embodiment, once the user returns to the parking structure, an application on the user's device by alerting the user about the location, either by text, voice, or other method, of the vehicle. The application may also allow for the user to inquire as to the location of the vehicle that may include a verbal, text, or mapping or route feature as to finding the vehicle. Further, once the user is within a certain distance of the vehicle, a vehicle sensor may detect the presence of the user or sense the presence of a key-fob or other user device, e.g., a smartphone, and emit a visual or auditory signal to draw the user's attention. Further, as previously mentioned, once the driver returns to the vehicle and exits the parking structure, upon obtaining a satellite communication connection, the vehicle may update its parking structure data to a server. Such updated parking information may include as previously described, the layout and mapping of the various parking levels, but it may also include enhanced mapping features such as the precise location of parked vehicles, the location of slanted ramps, flat levels, whether the ramps are for ascending or descending traffic, etc.

Once parked, such parking data, in an embodiment, may be shared, for example within a software application, with other family members or friends. Such information may include, possibly based on a subscription model, the location and status of the vehicle in addition to a mapping of the parking structure. In addition, if a family member may update or change their parking location then such information may be shared through some type of social media application. The same approach may be applied through a collective sharing of parking map intelligence, for example for any type of parking structure or mall, stadium, or other type of parking where various levels of parking detail and availability based on a subscription basis.

Method 1100 may then end.

The description and abstract sections may set forth one or more embodiments of the present disclosure as contemplated by the inventor(s), and thus, are not intended to limit the present disclosure and the appended claims.

Embodiments of the present disclosure have been described above with the aid of functional building blocks illustrating the implementation of specified functions and relationships thereof. The boundaries of these functional building blocks have been arbitrarily defined herein for the convenience of the description. Alternate boundaries may be defined so long as the specified functions and relationships thereof may be appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present disclosure should not be limited by any of the above-described exemplary embodiments.

Exemplary embodiments of the present disclosure have been presented. The disclosure is not limited to these examples. These examples are presented herein for purposes of illustration, and not limitation. Alternatives (including equivalents, extensions, variations, deviations, etc., of those described herein) will be apparent to persons skilled in the relevant art(s) based on the teachings contained herein. Such alternatives fall within the scope and spirit of the disclosure.

What is claimed is:

1. A method for mapping vehicle parking comprising:
receiving, by a sensor in a vehicle, a global navigation satellite system (GNSS) signal;
determining, based on the GNSS signal, a position of the vehicle;
entering, by the vehicle, into a parking structure, wherein, based on a location of the vehicle in the parking structure, a loss of reception of the GNSS signal;
tracking, based on one or more vehicle movement sensors, a movement of the vehicle within the parking structure after the loss of reception of the GNSS signal;
identifying, using an optical sensor in the vehicle, vehicle location information within the parking structure;
mapping, using one or more sensors within the vehicle and based on the tracking and identifying, based on simultaneous localization and mapping (SLAM), parking space mapping data;
recognizing, upon cessation of movement of the vehicle, using one or more sensors within the vehicle, a parking of the vehicle; and
determining a parking space position of the parked vehicle within the parking structure.

2. The method of claim 1, wherein the recognizing the parking of the vehicle further comprises determining that a transmission of the vehicle has been placed into a parking state and that an engine of the vehicle has been turned off.

3. The method of claim 1, further comprising transmitting the parking space mapping data to a mobile communication device.

4. The method of claim 3, further comprising transmitting the parking space mapping data from the mobile communication device to a server.

5. The method of claim 1, further comprising transmitting the parking space position of the parked vehicle to a mobile communication device.

6. The method of claim 1, further comprising augmenting, by a-priori parking space mapping information, the parking space mapping data.

7. The method of claim 1, further comprising determining, using dynamic programming, an optimized path to an open parking space within the parking structure.

8. The method of claim 7, wherein the determining of the optimized path is based on a location coordinate of a parking lot entrance, a speed of the vehicle, an elapsed time of travel of the vehicle, a direction of the vehicle, and a-priori parking space mapping information.

9. The method of claim 1, further comprising sharing the parking space mapping data with a third-party parking software application.

10. The method of claim 1, receiving from a server, parking space mapping data.

11. A system for mapping vehicle parking comprising:
a global navigation satellite system (GNSS) receiver, located within a vehicle, configured to receive a GNSS signal, wherein, based on the GNSS signal, a position of the vehicle is determined;
one or more vehicle movement sensors configured to track, upon entering into a parking structure and a subsequent loss of reception of the GNSS signal, a movement of the vehicle within the parking structure;
an optical sensor, in the vehicle, configured to identify vehicle location information within the parking structure;
one or more sensors, within the vehicle, configured to map, based on the tracking and identifying, using simultaneous localization and mapping (SLAM), parking space mapping data; and
the one or more sensors, within the vehicle, further configured to recognize, upon cessation of movement of the vehicle, a parking of the vehicle; wherein a determination is made of a parking space position of the parked vehicle within the parking structure.

12. The system of claim 11, further comprising a transmitter, within the vehicle, configured to transmit the parking space mapping data to a mobile communication device.

13. The system of claim 12, wherein the mobile communication device is further configured to transmit the parking space mapping data to a server.

14. The system of claim 11, further comprising a transmitter, within the vehicle, configured to transmit the parking space mapping data to a server.

15. The system of claim 11, further comprising a transmitter configured to transmit the parking space position of the parked vehicle to a mobile communication device.

16. The system of claim 11, further comprising a receiver, located in the vehicle, configured to receive, an optimized path to an open parking space within the parking structure determined by dynamic programming.

17. The system of claim 16, wherein the determining of the optimized path is based on a location coordinate of a parking lot entrance, a speed of the vehicle, an elapsed time of travel of the vehicle, a direction of the vehicle, and a-priori parking space mapping information.

18. The system of claim 11, further comprising a receiver, located within the vehicle, configured to receive from a server, parking space mapping data.

19. The system of claim 11, further comprising a receiver, located within the vehicle, configured to receive, a-priori parking space mapping information.

20. A method for mapping vehicle parking comprising:
receiving, by a sensor in a vehicle, a global navigation satellite system (GNSS) signal;
determining, based on the GNSS signal, a position of the vehicle;
entering, by the vehicle, into a parking structure, wherein, based on a location of the vehicle in the parking structure, a loss of reception of the GNSS signal;
tracking, based on one or more vehicle movement sensors, a movement of the vehicle within the parking structure after the loss of reception of the GNSS signal;
identifying, using an optical sensor in the vehicle, vehicle location information within the parking structure;
mapping, using one or more sensors within the vehicle and based on the tracking and identifying, based on simultaneous localization and mapping (SLAM), parking space mapping data;
recognizing, upon cessation of movement of the vehicle, using one or more sensors within the vehicle, a parking of the vehicle, wherein the recognizing the parking of the vehicle further comprises determining that a transmission of the vehicle has been placed into a parking state and that an engine of the vehicle has been turned off;
determining a parking space position of the parked vehicle within the parking structure;
transmitting the parking space mapping data and the parking space position of the parked vehicle to a mobile communication device;
transmitting the parking space mapping data from the mobile communication device to a server; and
determining, using dynamic programming, an optimized path to an open parking space within the parking structure.
